(19) United States
(12) Patent Application Publication
(10) Pub. No.: US 2008/0201451 A1
(43) Pub. Date: Aug. 21, 2008

(54) SYSTEMS AND METHODS FOR REAL-TIME MEDIA COMMUNICATIONS

(75) Inventors: Jen-Yu YU, Fengyuan City (TW); Hsin-Hua LEE, Hsinchu City (TW); Yeh-Kai CHOU, Yuanlin Town (TW); Chong-Yie CHANG, Hsinchu City (TW); Wen-Fang CHENG, Hsinchu City (TW); Kuan-Hung CHOU, Hsinchu City (TW)

Correspondence Address: Akin Gump LLP - Silicon Valley, 3000 El Camino Real, Two Palo Alto Square, Suite 400, Palo Alto, CA, 94306, US

(73) Assignee: INDUSTRIAL TECHNOLOGY RESEARCH INSTITUTE, Hsinchu (TW)

(21) Appl. No.: 11/944,218

(22) Filed: Nov. 21, 2007

Related U.S. Application Data
(60) Provisional application No. 60/901,932, filed on Feb. 16, 2007.

(51) Int. Cl. G06F 15/16

(52) U.S. Cl. 709/219

(57) ABSTRACT

A system for real-time media communication comprises a first server unit configured to interface between at least one user and a blog and a second server unit configured to process the real-time media content in a streaming mode. The first server unit comprises a publishing control module configured to identify an identity of a publisher of the at least one user, allow the publisher to transmit real-time media content if the identity of the publisher is authentic and receive a description of the real-time media content from the publisher, and a link module configured to obtain a location of the real-time media content so that the location of the real-time media content is accessible to the at least one user. The second server unit comprises a receiving module configured to receive the real-time media content, a recording module configured to record the real-time media content, and a dispatching module configured to provide the location of the real-time media content to the publishing module.

### BACKGROUND OF THE INVENTION

The present invention relates generally to real-time media communication and, more particularly, to systems and methods configured for publishing and receiving real-time media.

The continued growth in communications technologies and the emergence of the Internet as means for accessing data has accelerated the demand for publishing or sharing information over communication networks. The information, which may include audio, video, audio/video, or other content, may be transmitted from or received by mobile devices such as mobile phones, digital cameras, digital video cameras, digital players, personal digital assistants (PDAs) and mobile terminals over the communication networks. These mobile devices may perform various functions and may be able to communicate via wireless connections with other devices. For example, a single mobile device may provide Internet access, maintain a personal calendar, provide mobile telephony, and take digital photographs.

The editing and sharing of media content captured by a mobile device may be time-consuming and limited. As used herein, “media content” may refer to one or more content items, files, or bitstreames, including audio, video, audio/video, or other media. As an example of a media event such as a birthday party, each of the attendees of the special event may decide to capture the special event through use of digital photographs or video captured using their mobile devices. A considerable time after the event, the attendees may share their media content with each other or among viewers on a web log (blog) such as, for example, Nokia Lifeblog. Furthermore, each of the attendees may spend considerable time editing the media content prior to exchanging them with other attendees or viewers. That is, a conventional file management application such as the Nokia Lifeblog may not enable a user to real-time edit and share media content over the Internet. Moreover, although a web camera (or web cam) may serve as a real-time camera whose images can be accessed using the World Wide Web, such web cams may be stationary or immobile devices and can only share real-time images or information among limited number of persons.

Therefore, it may be desirable in some instances to have a system and a method capable of publishing and receiving real-time media content, which is accessible among a group of users. It may also be desirable to have a system and a method that may allow interactions among a publisher and viewers. For example, the system and method may allow users to real-time publish media content, collect responses from viewers and real-time edit media content being displayed based on the responses.

### BRIEF SUMMARY OF THE INVENTION

Examples of the present invention may provide a system for real-time media communication comprising a first server unit configured to interface between at least one user and a blog and a second server unit configured to process the real-time media content in a streaming mode. The first server unit comprises a publishing control module configured to identify an identity of a publisher of the at least one user, allow the publisher to transmit real-time media content if the identity of the publisher is authentic and receive a description of the real-time media content from the publisher, and a link module configured to obtain a location of the real-time media content so that the location of the real-time media content is accessible to the at least one user. The second server unit comprises a receiving module configured to receive the real-time media content, a recording module configured to record the real-time media content, and a dispatching module configured to provide the location of the real-time media content to the publishing module.

Some examples of the present invention may also provide a system for real-time media communication, the system comprising a registration module configured to assign an identity to at least one user upon registration and collect a description of interested contents from at least one subscriber of the at least one user, a publishing module configured to identify an identity of a publisher of the at least one user, allow the publisher to transmit real-time media content if the identity of the publisher is authentic and receive a description of the real-time media content from the publisher, a link module configured to obtain a location of the real-time media content so that the location of the real-time media content is accessible to the at least one user, and a notifying module configured to notify a group of subscribers of the real-time media content.

Examples of the present invention may further provide a system for real-time media communication, the system comprising a receiving module configured to receive data from a publisher and identify whether the data include a command or a payload, the receiving module performing an initiation process for transmission of the real-time media content if the data include a command on initiation, identifying a session for real-time media content if the payload includes the real-time media content and closing a session for the real-time media content if the data include a command on closing, a recording module configured to record the real-time media content, and a dispatching module configured to provide a location of the real-time media content.

Examples of the present invention may also provide a method of real-time media communication. The method comprises configuring a first server unit to interface between at least one user and a blog, configuring a second server unit to process the real-time media content in a streaming mode, in the first server unit identifying an identity of a publisher of the at least one user, allowing the publisher to transmit real-time media content if the identity of the publisher is authentic, receiving a description of the real-time media content from the publisher, and obtaining a location of the real-time media content so that the location of the real-time media content is accessible to the at least one user, and in the second server unit receiving the real-time media content, recording the real-time media content and providing the location of the real-time media content.

Some examples of the present invention may also provide a method of real-time media communication, the method comprising assigning an identity to at least one user upon registration, collecting a description of interested contents from at least one subscriber of the at least one user, identifying an identity of a publisher of the at least one user, allowing the publisher to transmit real-time media content if the identity of the publisher is authentic, receiving a description of the real-time media content from the publisher, obtaining a location of the real-time media content so that the location of the real-time media content is accessible to the at least one user, and notifying a group of subscribers of the real-time media content.

Examples of the present invention may further provide a communication device for real-time media communication, the device comprising a capture module configured to capture real-time media content, an encoder configured to encode the real-time media content into compressed data, a streaming module configured to form the compressed data from the encoder into packets in the form of a bit stream, and a logic control unit configured to provide a format for the real-time media content and send the packets in real time.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1A is a schematic diagram of a system capable of real-time media communication consistent with an example of the present invention;

FIG. 1B is an exemplary block diagram of a blog server unit and a streaming server unit illustrated in FIG. 1A;

FIG. 1C is an exemplary block diagram of a communication device illustrated in FIG. 1A;

FIGS. 2A to 2D are flow charts illustrating a method of real-time media communication consistent with an example of the present invention;

FIGS. 3A to 3C are flow charts illustrating a method of real-time media communication consistent with another example of the present invention;

FIGS. 4A and 4B are flow charts illustrating a method of real-time media communication consistent with still another example of the present invention;

FIGS. 5A and 5B are flow charts illustrating a method of real-time media communication consistent with yet another example of the present invention;

FIG. 6 is a flow diagram illustrating a method of publishing media content consistent with an example of the present invention; and

FIGS. 7A, 7B and 7C are exemplary flow diagrams illustrating a method of real-time media communication consistent with an example of the present invention.

### DETAILED DESCRIPTION OF THE INVENTION

Reference will now be made in detail to the present embodiments of the invention, examples of which are illustrated in the accompanying drawings. Wherever possible, the same reference numbers will be used throughout the drawings to refer to the same or like parts.

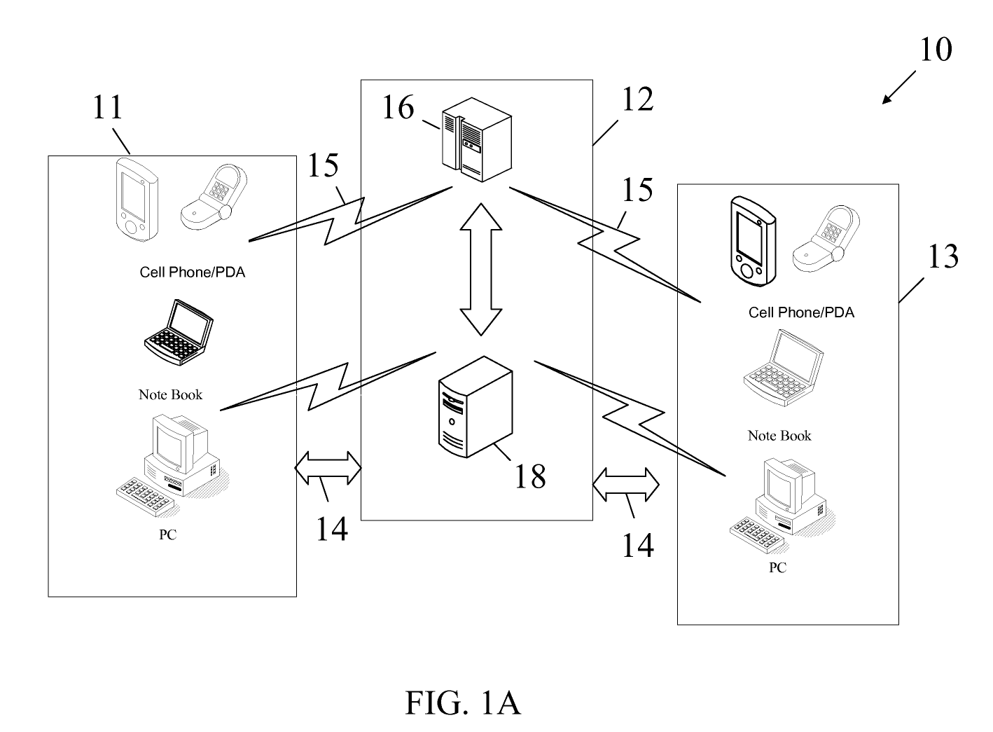

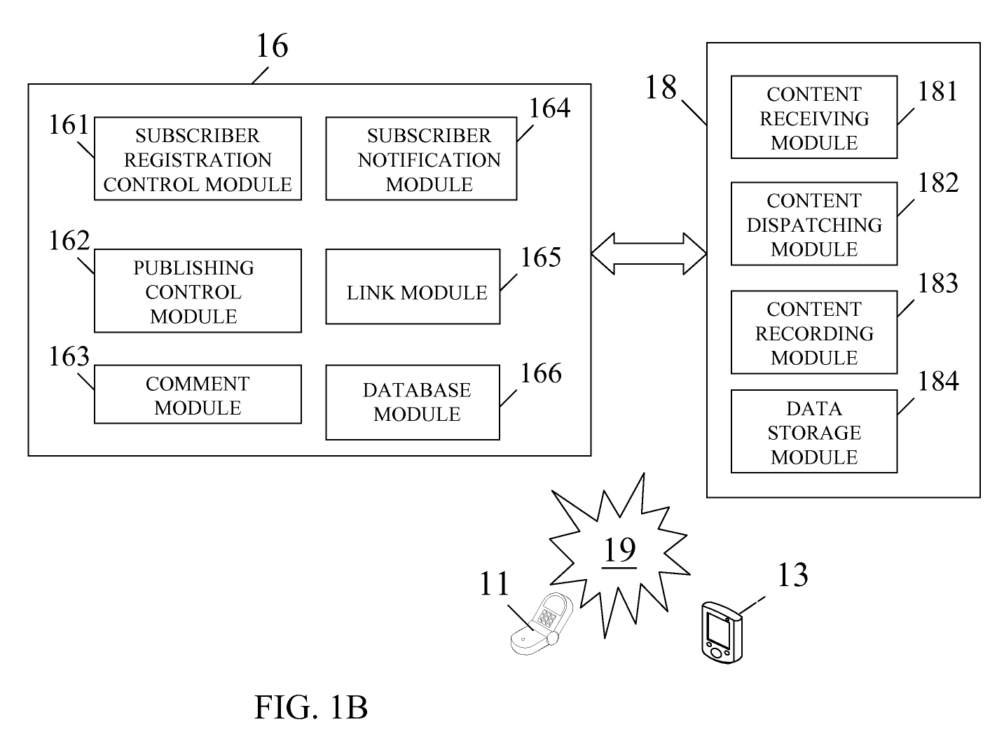

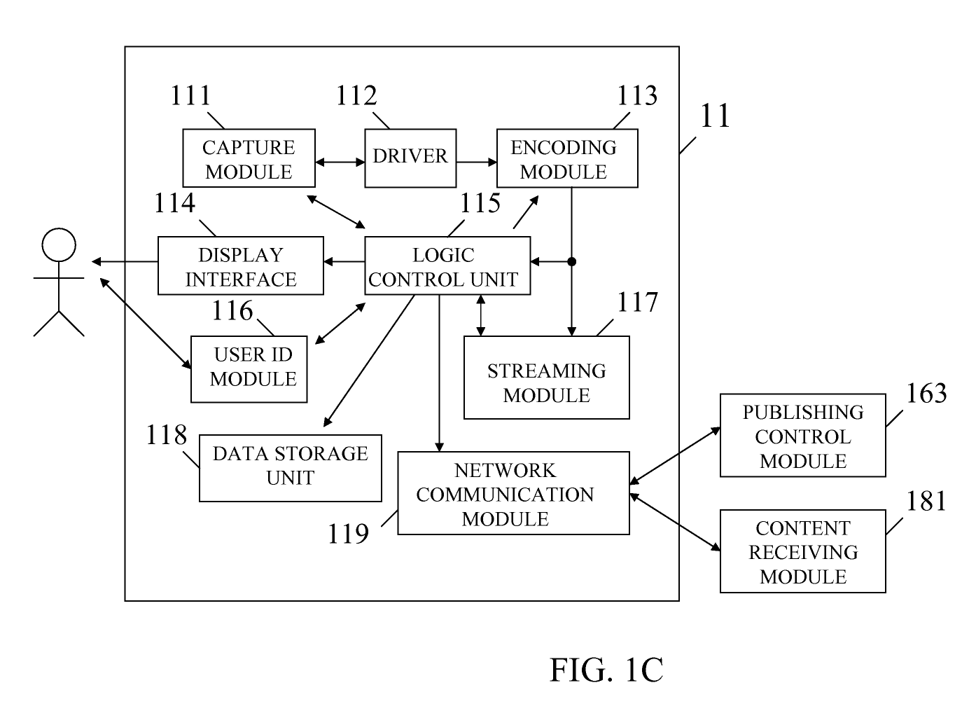

FIG. 1A is a schematic diagram of a system 10 capable of real-time media communication consistent with an example of the present invention. Referring to FIG. 1A, the system 10 may include one or more communication devices 11 at a publisher side, a server unit 12 and one or more communication devices 13 at a subscriber or receiver side. Each of the communication devices 11 and 13 may include but is not limited to a mobile phone, cell phone, digital camera, digital video camera, digital player, personal digital assistant (PDA), personal computer (PC) or notebook computer, which may be configured to support communications over a communication network or the Internet. The communication devices 11 and 13 may be connected to the server unit 12 by wired connections 14 or wireless connections 15. In one example, the wireless connection may include third generation (3G), Wireless Fidelity (WiFi) technology, and/or other communication mechanisms. WiFi may refer to a brand originally licensed by the WiFi Alliance to describe the underlying technology of wireless local area networks (WLAN) based on the IEEE 802.11 specifications. WiFi may be used for mobile computing devices, such as laptops, in LANs, and for more services, including Internet and Voice over IP (VoIP) phone access.

The server unit 12 may further include a blog server unit 16 and a streaming server unit 18, each of which may include a computer, a workstation or a workstation computer. The blog server unit 16 may be configured to serve as an interface between the communication device 11 or 13 and a blog, while the streaming server unit 18 may be configured to process media content to or from the communication device 11 or 13 in real-time. Specifically, the blog server unit 16 may be configured to receive real-time media content information such as a location, link address and description of an audio, video or audio-/video content, and broadcast a message on the publishing of the real-time media content to subscribers. Furthermore, the blog server unit 16 may also provide a location of the streaming server unit 18 to a publisher for publishing the real-time media content, and broadcast the location of the streaming server unit 18 to subscribers to facilitate retrieval of the real-time media content. The location of the streaming server unit 18 in one example may include an IP address in an RTSP format, for example, rtsp:\\140.96.112.102\itri. The streaming server unit 18 may be configured to receive a request for connection thereto from the communication device 11 or 13 and receive a real-time media content such as an audio, video and audio-/video content, and provide a real-time streaming media content to the communication device 11 or 13. Furthermore, the streaming server unit 18 may record real-time media content in a media file, which may eliminate the need of uploading the media content at a later time by a publisher. In this context “streaming” may refer to a mode of multi-media processing which allows a user to download multi-media content while playing the already downloaded portions of the multi-media content. Unlike a conventional “download-and-play” mode that only allows a user to play multi-media content when the whole multi-media content is downloaded, the “streaming” mode is able to support real-time multi-media processing. The functions of the blog server unit 16 and the streaming server unit 18 will be discussed below.

FIG. 1B is an exemplary block diagram of the blog server unit 16 and the streaming server unit 18 described and illustrated with reference to FIG. 1A. Referring to FIG. 1B, the blog server unit 16 may include plural function blocks 161 to 166, which may be implemented in hardware or software. If implemented in hardware, the function blocks 161 to 166 may be fabricated in an integrated chip (IC). If implemented in software, the function blocks 161 to 166 may be installed as a portion of operating system (OS) in a computer or workstation. In the blog server unit 16, a subscriber registration control module 161 may be configured to process subscriber registration. The subscriber registration control module 161 may assign an identity to a user upon registration through, for example, the communication device 11 or 13. During the registration, the user, which later becomes a subscriber of the system 10 when the registration is recognized, may be requested by the subscriber registration module 161 to identify or express his or her interested item(s). The items may include but are not limited to a classification of media content, a specific publisher or ratings given by subscribers to media content. Furthermore, the items, for example, food, traveling and friends, may be provided by the blog server unit 16 at the registration to facilitate a user's selection, or created by a subscriber at a later time based on media content of the subscriber's interest. In one example, each of the items may include a web page of a blog under the management of the blog server unit 16. In another example, a personal web page may be created for a subscriber to facilitate notification of newly published media content of the subscriber's interest.

Furthermore, a publishing control module 162 may be configured to process the publishing of real-time media content. A subscriber may be required to apply for or registered with a web page of a blog of the system 10 before he or she is allowed to publish a media content in the system 10. Specifically, a publisher of the system 10 may refer to a manager or owner of a web page, who is authorized to edit or maintain his or her personal web page. The blog may refer to a website where entries may be made in a journal style and displayed in a reverse chronological order. The blog may include text, images, video, audio, files and links to other blogs or web pages, and allow subscribers to leave comments in an interactive format. A comment module 163 may be configured to process a subscriber's or a publisher's comments on real-time media content. The system 10 may be configured to enable a subscriber or a publisher to real-time comment on media content being published.

Furthermore, a subscriber notification module 164 may be configured to notify subscribers of real-time media content of their interests. A link module 165 may be configured to provide a location for the publishing of real-time media content. The location for the real-time media content, which may take the form of, for example, http:\\140.96.112.102\itri, may refer to a universal resource locator (URL), a universal resource identifier (URI), a web address of a web page, and the like. A database module 166 may be configured to provide access for information such as system logs, user data and media data.

The streaming server unit 18 may include a content receiving module 181, a content dispatching module 182, a content recording module 183 and a data storage module 184. The modules 181 to 184, like the modules 161 to 166, may be implemented in hardware or software, depending on design complexity and operation speed requirements. The content receiving module 181 may be configured to receive real-time media content transmitted from the communication device 11 of a publisher. The content dispatching module 182 may be configured to provide a location of real-time media content and dispatch the real-time media content to subscribers. The content recording module 183 may be configured to record real-time media content transmitted from the communication device 11 of a publisher. The data storage module 184 may be configured to store the recorded media content.

In an example according to the present invention, communications between the publisher's communication device 11 and one of the publishing control module 162, the content receiving module 181 and the comment module 163 may be achieved through a mobile or wireless/Internet Protocol (IP) network connection 19. Furthermore, communications between the subscriber's communication device 13 and one of the subscriber notification module 164, the streaming server unit 18 and the comment module 163 may also be achieved through the mobile or wireless/Internet Protocol (IP) network connection 19. The mobile or wireless/IP network connection may employ general mobile/wireless network techniques such as Global System for Mobile Communications (GSM) and Code Division Multiple Access (CDMA) under second-generation (2G) protocols, General Packet Radio Service (GPRS) under second and a half generation (2.5G) protocols, wireless local area network (WLAN), and Wideband Code Division Multiple Access (WCDMA), Universal Mobile Telecommunications System (UMTS), Enhanced Data Rate for GSM Evolution (EDGE), Wireless EDGE (WEDGE), CDMA2000, Time Division-Synchronous Code Division Multiple Access (TDSCDMA) under third-generation (3G) and 3G-related protocols, High-Speed Downlink Packet Access (HSDPA) under third and a half generation (3.5G) protocols and Worldwide Interoperability for Microwave Access (WiMAX).

The above-mentioned GSM may refer to a standard for mobile phones. CDMA may refer to a form of multiplexing, a multiple access scheme and a digital cellular phone system based on the multiple access scheme. GPRS may refer to a mobile data service available to users of, for example, GSM. A 2G cellular system combined with GPRS may often be described as “2.5G”, that is, a technology between the 2G and 3G. WLAN may refer to a wireless network configured to link two or more computers without using wires. WCDMA may refer to a type of 3G cellular network, and technically may refer to a wideband spread-spectrum mobile air interface that utilizes the direct sequence CDMA signalling method to achieve a higher speed transmission than the TDMA signaling method employed by GSM networks. UMTS may refer to one of the 3G mobile phone technologies. UMTS may sometimes be termed 3GSM, emphasizing the combination of the 3G nature of the technology and the GSM standard which it was designed to succeed. EDGE or WEDGE may refer to a digital mobile phone technology that allows for increased data transmission rate and improved data transmission reliability. The EDGE or WEDGE may generally be classified as a 2.75G network technology.

Furthermore, CDMA2000 may refer to a family of 3G mobile telecommunications standards that use CDMA, a multiple access scheme for digital radio, to send voice, data, and signalling data such as a dialed telephone number between mobile phones and cell sites. TDSCDMA may refer to a 3G mobile telecommunications standard based on spread spectrum CDMA technology. HSDPA may refer to a 3G mobile telephone protocol, which may provide a smooth evolutionary path for UMTS-based networks allowing for higher data transfer speeds. WiMAX may be defined as Worldwide Interoperability for Microwave Access by the WiMAX Forum, formed in June 2001 to promote conformance and interoperability of the IEEE 802.16 standard.

Moreover, referring to FIG. 1B, the subscriber notification module 164 may be configured to notify a subscriber of his or her interested media contents in various ways. Examples of technologies to enable the notification may include but are not limited to WAP Push, SMS, MMS, RSS, Push Mail and Remote Method Invocation. Wireless Application Protocol (WAP) may refer to an open international standard for applications that use wireless communication. WAP may be used to enable access to the Internet from a mobile phone or PDA. WAP Push may refer to a specially encoded message which includes a link to a WAP address. Short Message Service (SMS) may refer to a service available on most digital mobile phones, which permits the sending of short messages or text messages between mobile phones or other handheld devices. Multimedia Messaging Service (MMS) may refer to a standard for telephony messaging systems that allow sending messages including multimedia objects (e.g., images, audio, video, rich text) as well as text messages as in SMS. RSS may refer to a family of web feed formats used to publish frequently updated digital content, such as blogs, news feeds or podcasts. The initials “RSS” are variously used to refer to the standards of Really Simple Syndication (RSS 2.0), Rich Site Summary (RSS 0.91, RSS 1.0) and RDF Site Summary (RSS 0.9 and 1.0).

Furthermore, Push mail may be used to describe e-mail systems that provide an “always-on” capability, in which new e-mail may be instantly and actively transferred or pushed as it arrives by a mail delivery agent (MDA), that is a mail server, to the mail user agent (MUA), that is, an email client. The Java Remote Method Invocation (RMI) Application Programming Interface (API), or Java RMI, may refer to a Java application programming interface for performing the object equivalent of remote procedure calls. Remote procedure call (RPC) is a technology that allows a computer program to cause a subroutine or procedure to execute on another computer without the programmer explicitly coding the details for this remote interaction. That is, the programmer would write essentially the same code whether the subroutine is local to the executing program, or remote on some other computer reachable by network. When the software in question is written using object-oriented principles, RPC may be referred to as remote invocation or remote method invocation.

FIG. 1C is an exemplary block diagram of the communication device 11 described and illustrated with reference to FIG. 1A. Each of the communication devices 11 and 13 may be configured not only to receive a real-time media content but also to publish a real-time media content. The streaming server unit 18 may real-time establish a link or connection between the real-time media content and a web page or blog. Consequently, the capability of real-time publishing may enable a subscriber with the communication device 13 to view in real-time in the web page the media content being captured and published by a publisher with the communication device 11.

Referring to FIG. 1C, the communication device 11 may include a capture module 111, a driver 112, an encoding module 113, a display interface 114, a logic control unit 115, a user ID module 116, a streaming module 117, a data storage unit 118 and a network communication module 119. The capture module 111 may include one or more of an optical device such as a lens or an audio device such as a microphone. In one example, the communication device 11 may include a mobile phone or PDA and the capture module 111 may be built in the mobile phone or PDA. In another example, the communication device 11 may include a PC or notebook computer and the capture module 111 may be external to the PC or notebook computer. In the case of an external device, an interface such as, for example, universal serial bus (USB), Bluetooth or WiFi, between the capture module 111 and the PC or notebook computer may be used. The capture module 111 may be driven and controlled by the driver 112, and may be configured to support capture of image/video or audio data of various formats. The driver 112 may be initiated prior to the publishing of media content through the communicating device 11. Furthermore, the driver 112 may send the formats available for the capture module 111 to the logic control unit 115, which in turn may identify a suitable format for the media content to be published. The formats for the capture module 111 may include video formats regarding resolution and frame rate, or audio formats having a sample rate of approximately 8000 with bits per sample (BPS) being approximately 16. Furthermore, the suitable formats for the media content may include video formats such as RGB 565 and YV 12 and audio formats such as 1-channel and 2-channel.

Based on the format identified by the logic control unit 115, the encoding module 113 may encode image/video signals or audio signals sent from the driver 112 in a format available for publishing in the system 10. The formats used in the encoding module 113 may include, for example, “Moving Picture Experts Group” (MPEG)-4, H.264, etc. for video compression or “Adaptive Multi-rate” (AMR), “Advanced Audio Coding” (AAC), MPEG-1 Layer 3 (MP3), etc. for audio compression. The streaming module 117 may be configured to form the image/video signals or audio signals from the encoding module 113 into packets in the form of a bit stream, which may then be sent to the logic control unit 115. The logic control unit 115 may send the packets through the network communication module 119 to the publishing control module 163 and the content receiving module 181.

The logic control unit 115 may include a central processing unit (CPU), which is capable of processing software applications for real-time media communication in the system 10. The software applications may be stored in a read-only memory (ROM) device in the data storage unit 118, or installed at a later time after the purchase of the communication device 11 in a random access memory (RAM) device in the data storage unit 118. The user ID module 116 may include a hardware interface capable of verifying the identity of a user. The ID verification may be implemented by password check, fingerprint identification, voiceprint identification or other suitable methods. A user may not be allowed to publish media content until the ID verification is passed.

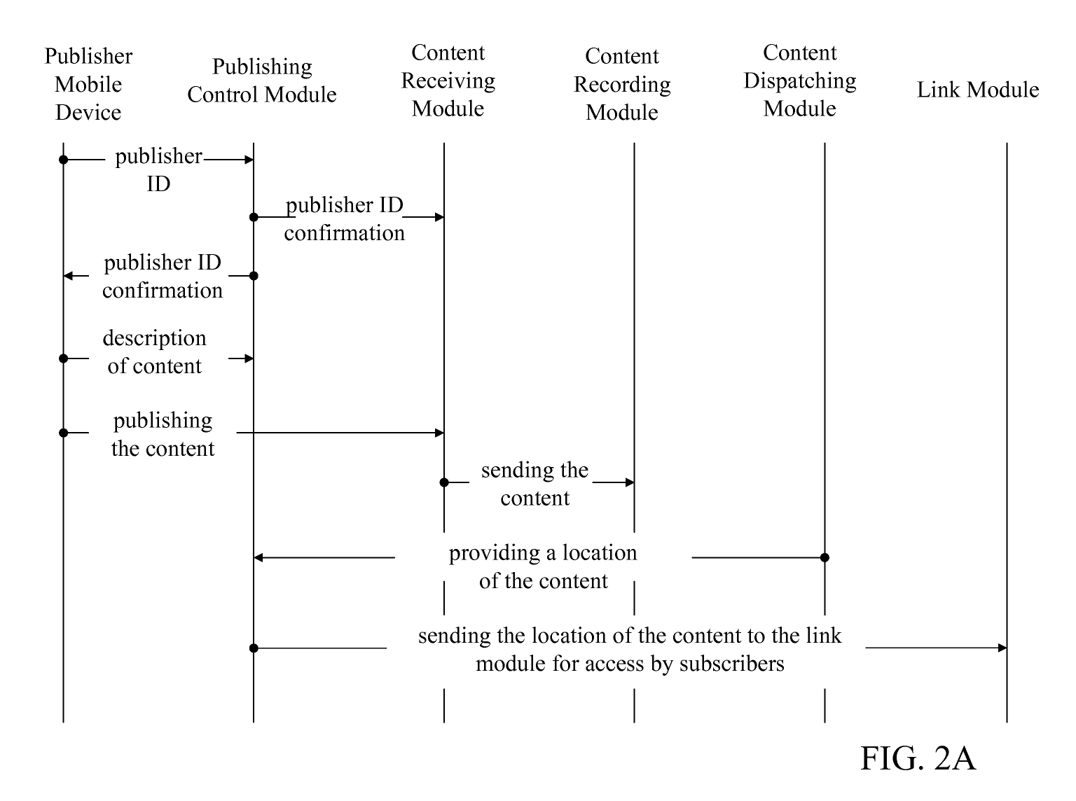

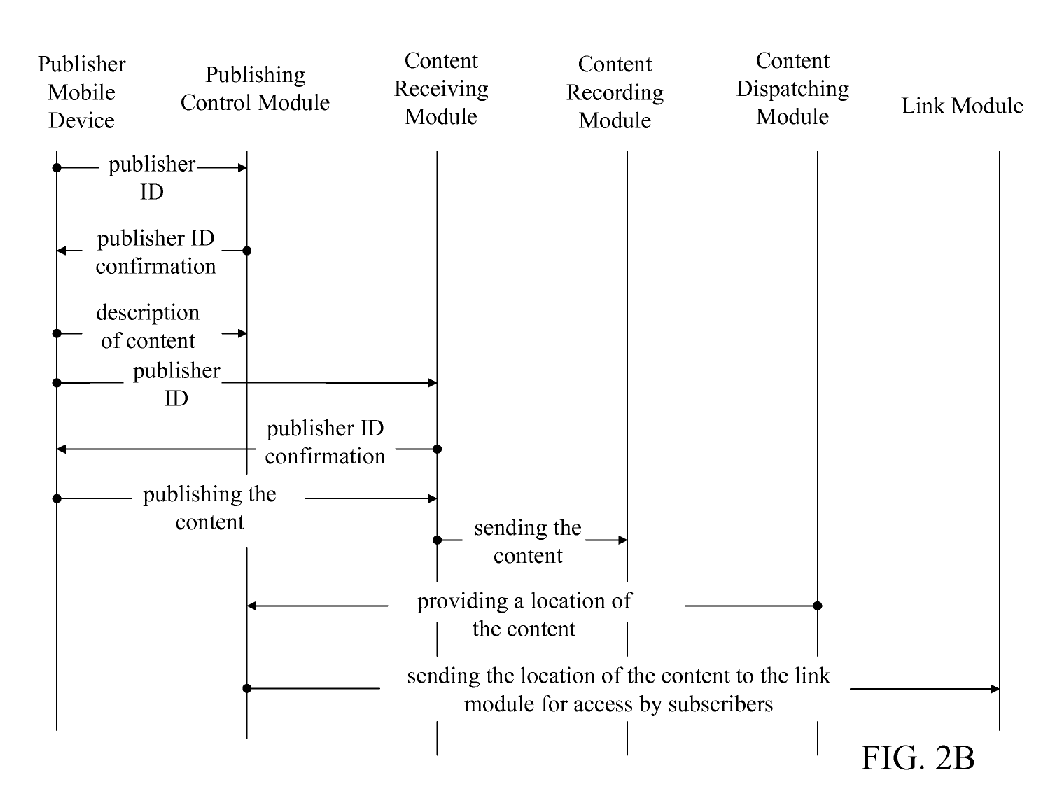

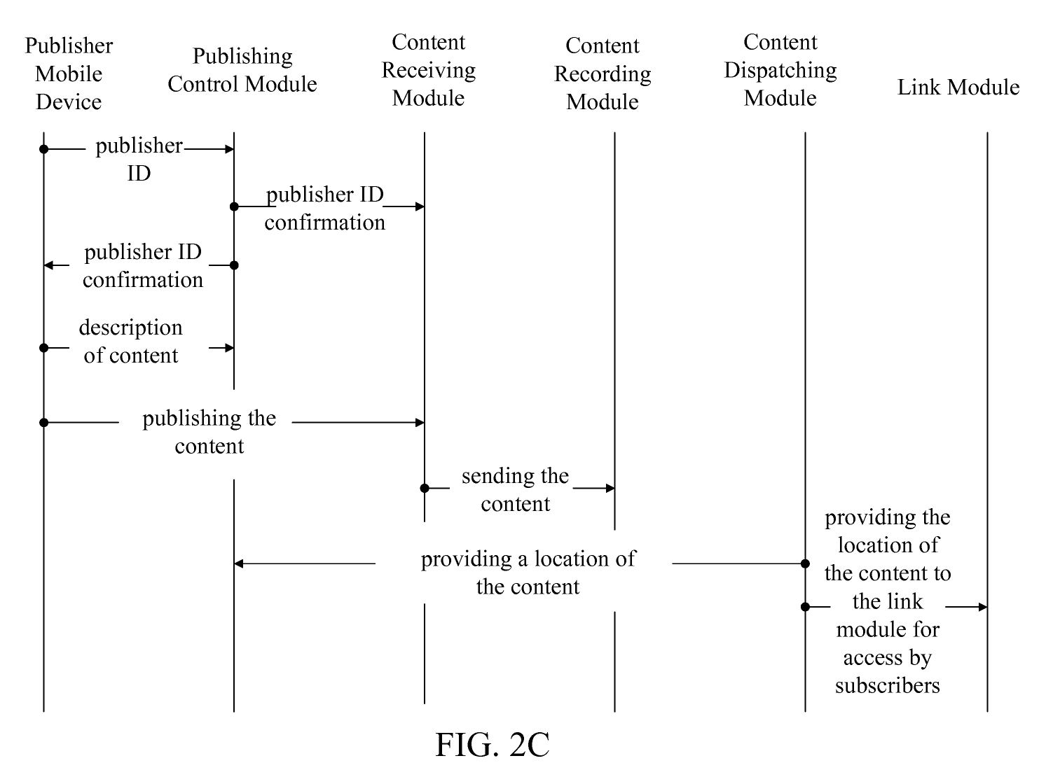

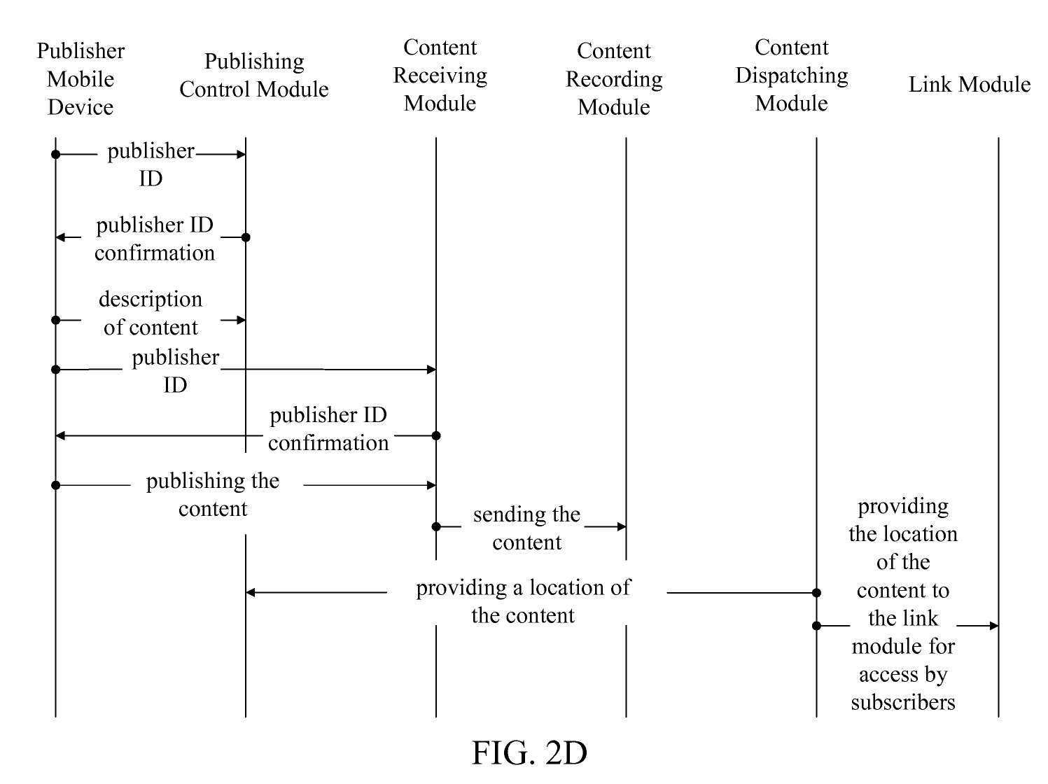

FIGS. 2A to 2D are flow charts illustrating a method of real-time media communication consistent with an example of the present invention. Specifically, FIGS. 2A to 2D illustrate that the blog server unit 16 may function to interface between a user and a blog and the streaming server unit 18 may function to link a real-time media content to the blog. Referring to 2A, and with reference to FIG. 1B, a user may be requested to enter his or her ID via the communication device 11 or 13 such as a mobile device. The publishing control module 162 may verify the user ID. If the user ID is authentic, a message of confirmation may be sent to the user and the content receiving module 181, allowing the user to publish media content and the content receiving module 181 to receive the media content. After receiving the message of confirmation, the user may provide to the publishing control module 162 a description in the form of, for example, text, image, voice or other formats, which may describe features of the real-time media content to be published. The description may help a subscriber identify whether the media content is one in which the subscriber may be interested. The blog server unit 16, which may serve as an interface between a user and a blog as previously discussed, may provide the location of the streaming server unit 18 to the user with the communication device 11 or 13. The user may then provide the real-time media content to the content receiving module 181 of the streaming server unit 18, which may be able to process the real-time media content in the streaming mode as previously discussed. The real-time media content may include audio, video or audio/video data captured in real-time by the user's communication device 11. The content recording module 183 may record the real-time media content in a media file in a format such as, for example, 3GP, MP4 and AVI. Recording real-time media content in the content recording module 183 may save a user's effort uploading the media content and may facilitate a subscriber to access the media content immediately after the media content is recorded. The content dispatching module 182 at the media processing server, i.e., the streaming server unit 18, may provide a location for publishing the real-time media content to the publishing control module 162 at the interface server, i.e., the blog server unit 16 so that the location may be accessible to subscribers via the interface server. The location for publishing the real-time content may include a URL or URI. The publishing control module 162 may then provide the location to the link module 165 for real-time access by subscribers.

Referring to FIG. 2B, the method is similar to that described and illustrated with reference to FIG. 2A except that, for example, the user ID may be verified at the content receiving module 181 as well as the publishing control module 162.

Referring to FIG. 2C, the method is similar to that described and illustrated with reference to FIG. 2A except that, for example, the content dispatching module 182 may provide a location for the real-time media content to the link module 165 as well as the publishing control module 162.

Referring to FIG. 2D, the method is similar to that described and illustrated with reference to FIG. 2B except that, for example, the content dispatching module 182 may provide a location for the real-time media content to the link module 165 as well as the publishing control module 162.

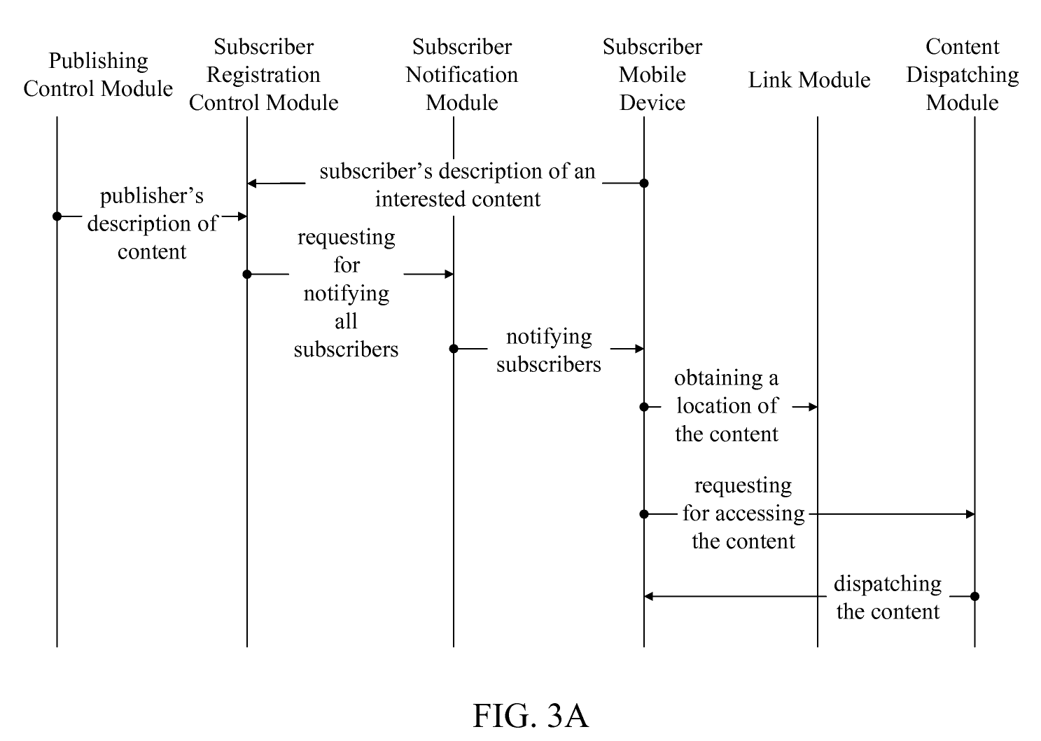

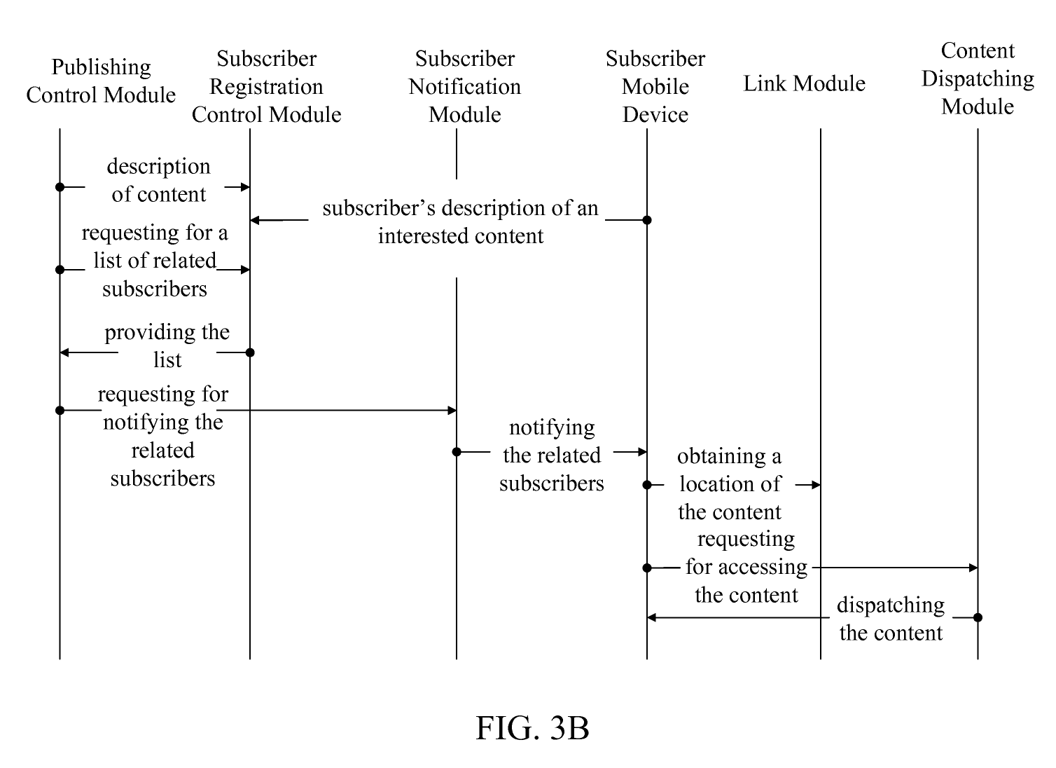

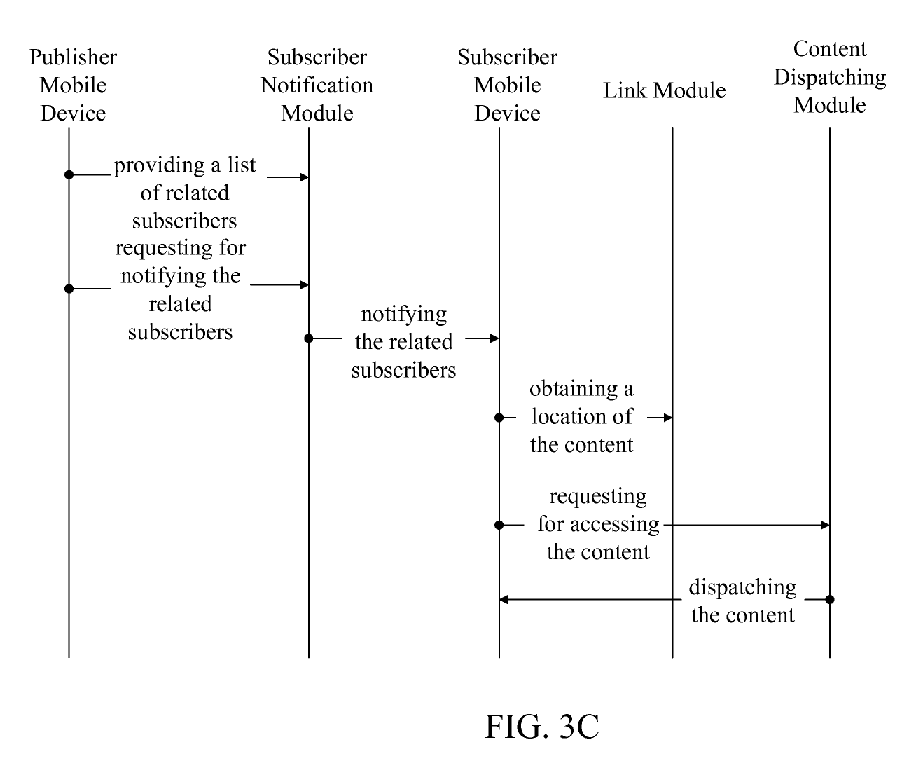

FIGS. 3A to 3C are flow charts illustrating a method of real-time media communication consistent with another example of the present invention. Specifically, FIGS. 3A to 3C illustrate that the blog server unit 16, as an interface between a user and a blog, may function to notify subscribers in the system 10 of the publishing of media content in real-time. Referring to FIG. 3A, also referring to FIG. 1B, the publishing control module 162 may provide a description, which is sent from the user's communication device 11, to the subscriber registration control module 161. Since upon registration subscribers may have expressed or indicated their favorite media classifications, in response to the description for a media content, the subscriber registration control module 161 may request the subscriber notification module 164 to notify all of the subscribers in the system 10. The subscriber notification module 164 may inform the subscribers via the subscribers' communication devices 13 such as mobile devices. The subscribers may obtain a location for the real-time media content from the link module 165, which may be sent from the content dispatching module 182 via the publishing control module 162 or directly from the content dispatching module 182. When the location for the real-time media content is available, the subscribers may request and receive the real-time media content from the content dispatching module 182.

Referring to FIG. 3B, the publishing control module 162 may provide the description to the subscriber registration control module 161 and request a list of subscribers having an interest in the real-time media content, i.e., a list of subscribers related to the description. After receiving the list, the publishing control module 162 may request the subscriber notification module 161 to inform the related subscribers on the list of the real-time media content currently being published. The related subscribers may then obtain a location for the real-time media content from the link module 165 and may request and receive the real-time media content from the content dispatching module 182.

Referring to FIG. 3C, the publisher may provide a list of related subscribers and request the subscriber notification module 164 to notify the related subscribers on the list provided by the publisher.

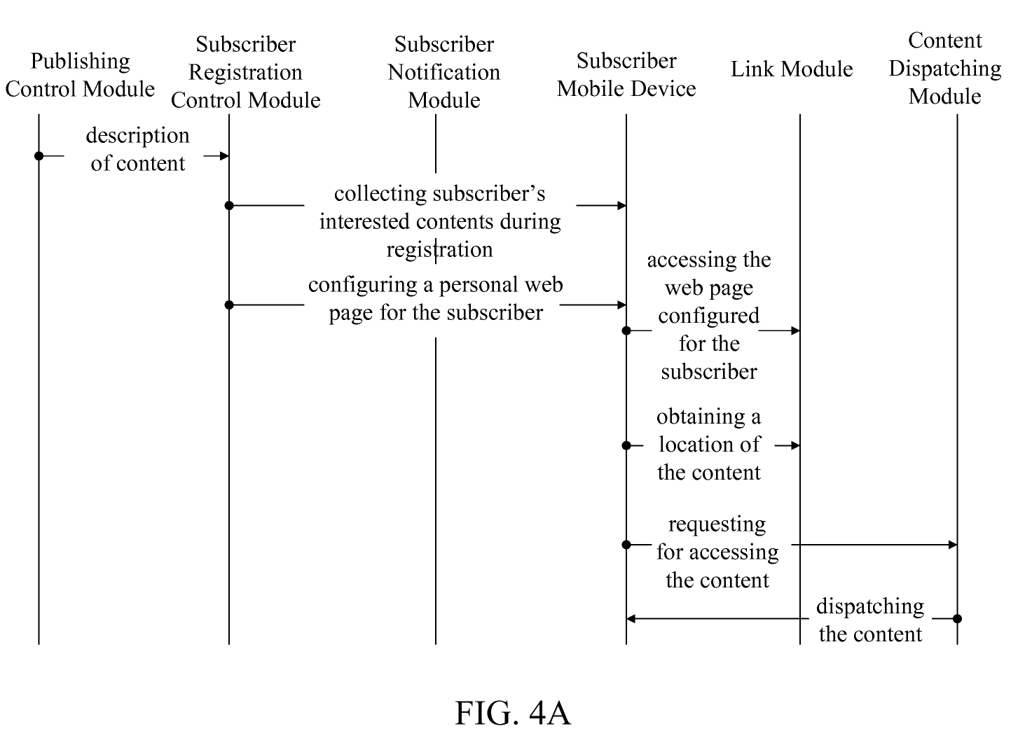

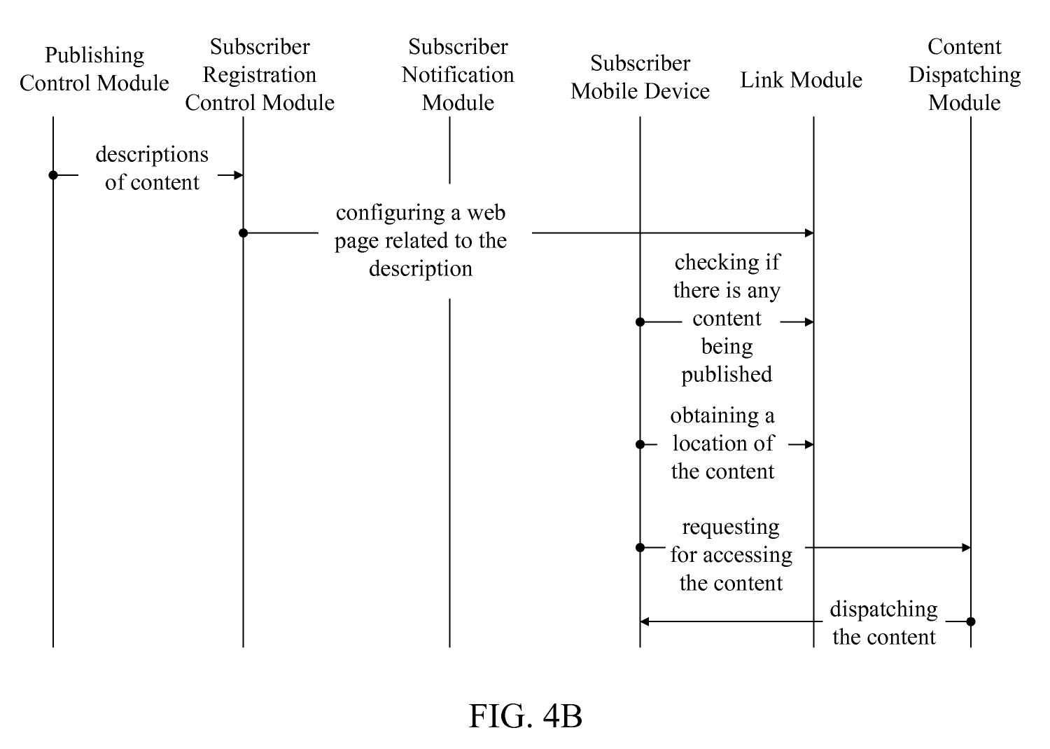

FIGS. 4A and 4B are flow charts illustrating a method of real-time media communication consistent with still another example of the present invention. Referring to FIG. 4A, in addition to a description for a real-time media content sent from the publishing control module 162, the subscriber registration control module 164 may, during a registration stage, receive one or more descriptions related to a media content which may interest a subscriber. Based on the description from the subscriber, the subscriber registration control module 161 may configure a personal web page for the subscriber. The personal web page may facilitate the subscriber to access media content in which the subscriber may be interested and may facilitate the subscriber to check whether there is media content related to the subscriber's description being published. The subscriber may access the personal web page via the subscriber's communication device 13 without a notification message from the subscriber notifying module 164, and obtain a location of media content in the web page from the link module 165. In response to the subscriber's request, the content dispatching module 182 may send the media content to the subscriber's communication device 13.

Referring to FIG. 4B, based on a number of descriptions related to a same item from the publishing control module 162, the subscriber registration control module 161 may configure a public web page for the item, which may be accessible to all of the subscribers in the system 10. Without a notification message from the subscriber notification module 164, a subscriber may check whether there is any real-time media content being published in the public web page for the item.

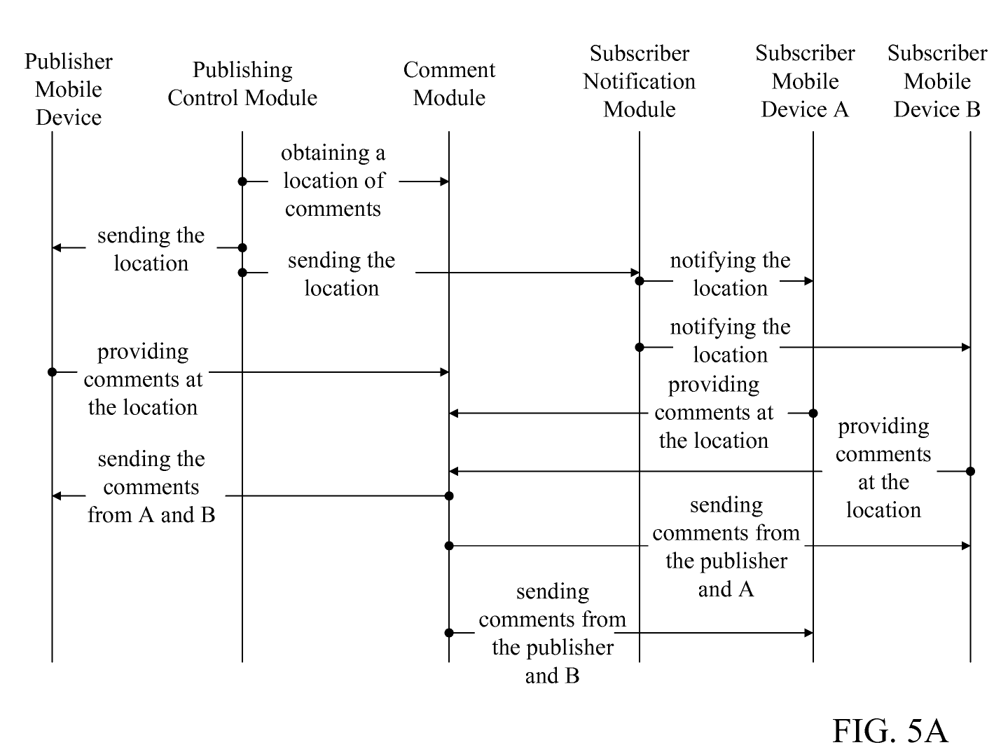

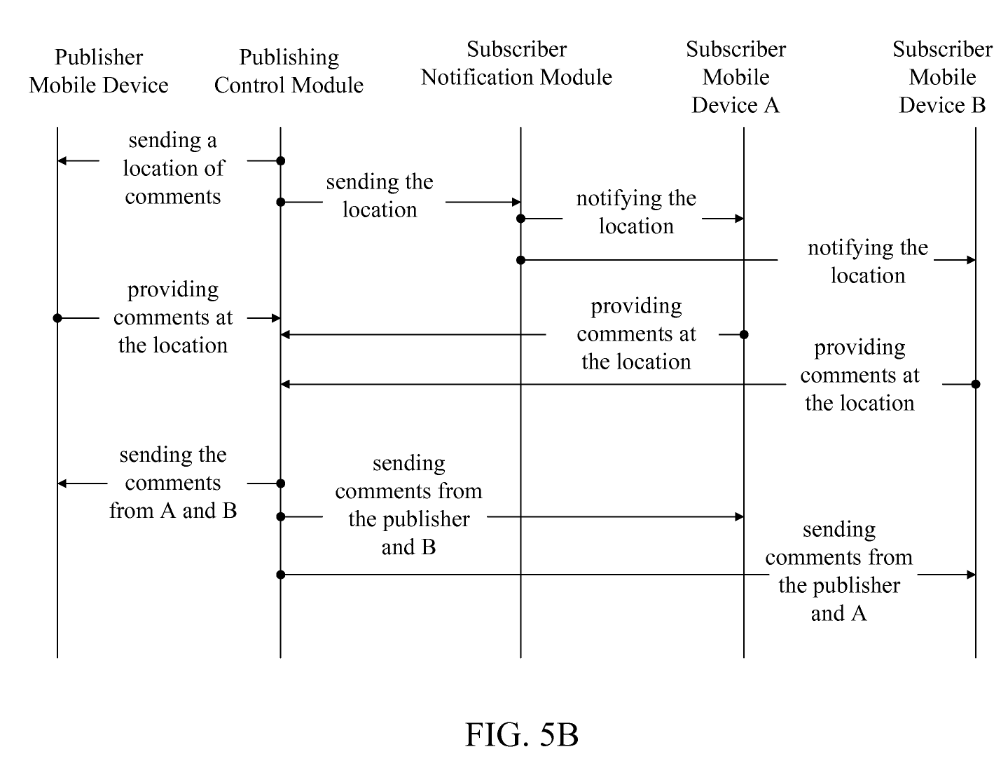

FIGS. 5A and 5B are flow charts illustrating a method of real-time media communication consistent with yet another example of the present invention. The method according to the present invention may allow publishers and subscribers to make comments on real-time media content. Referring to FIG. 5A, the publishing control module 162 may obtain from the comment module 163 a location for the publisher and subscribers to leave comments. The location for comments may include a web page. The publishing control module 162 may then send the location to the publisher and the subscriber notification module 164, which may in turn notify subscribers, for examples, A and B of the location. Comments on real-time media content from one or more of the publisher or the subscribers A and B may be collected at the publishing control module 162, and may then be accessible by the publisher and the subscribers A and B at the location. In another example, users of the system 10 may be allowed to comment on media content which has been previously stored in the system 10.

Referring to FIG. 5B, the method is similar to that described and illustrated with reference to FIG. 5A except that, for example, the publishing control module 162 may also function to serve as a comment module so that the comment module 163 illustrated in FIG. 5A may be eliminated.

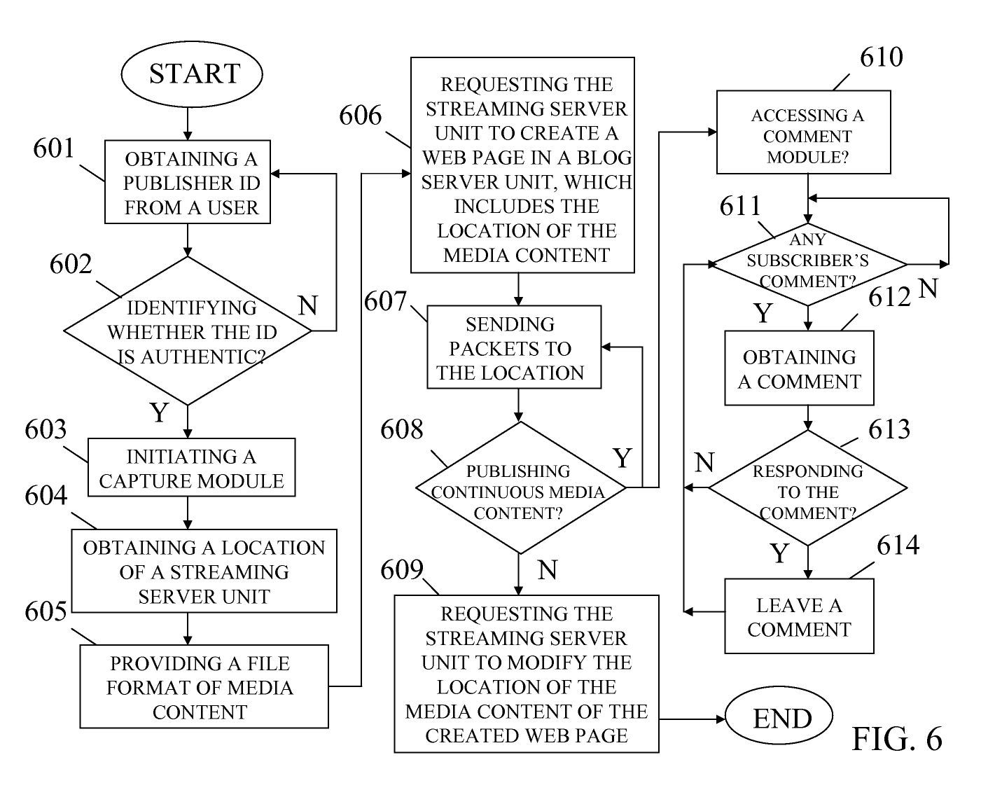

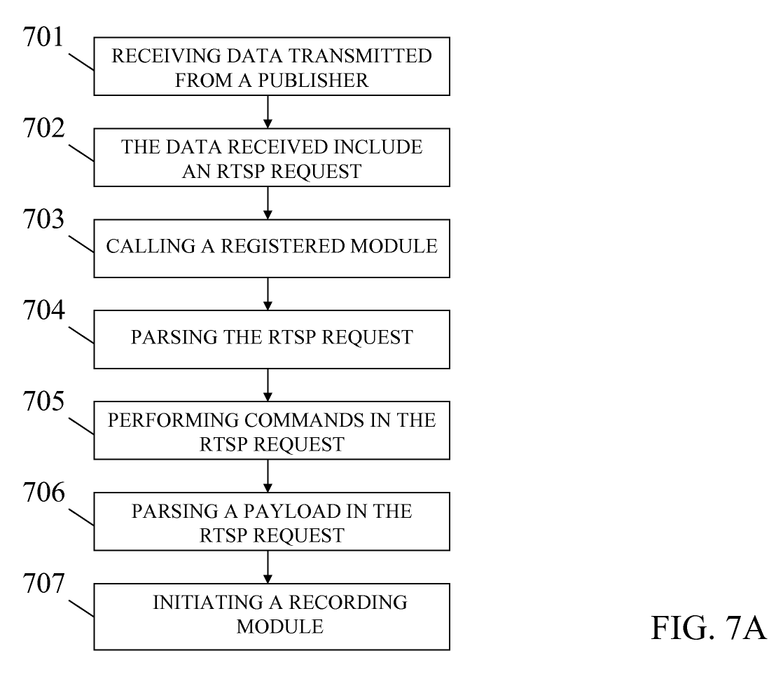

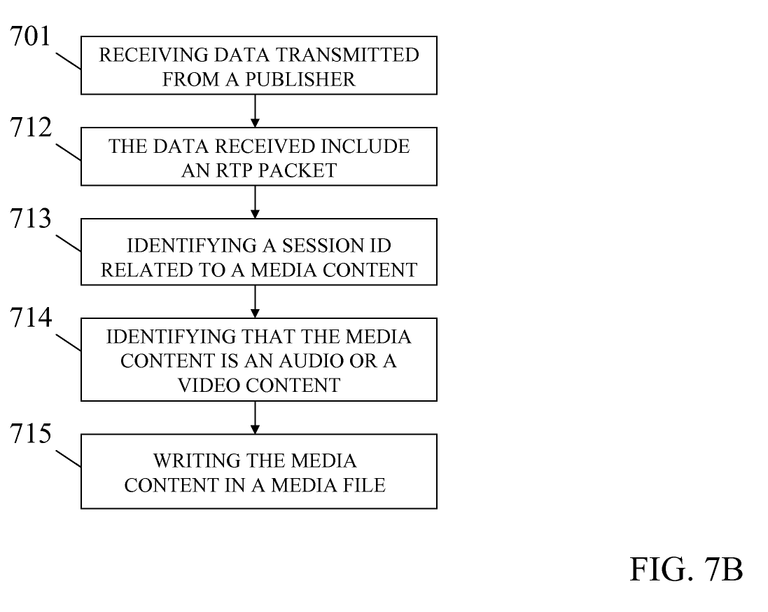

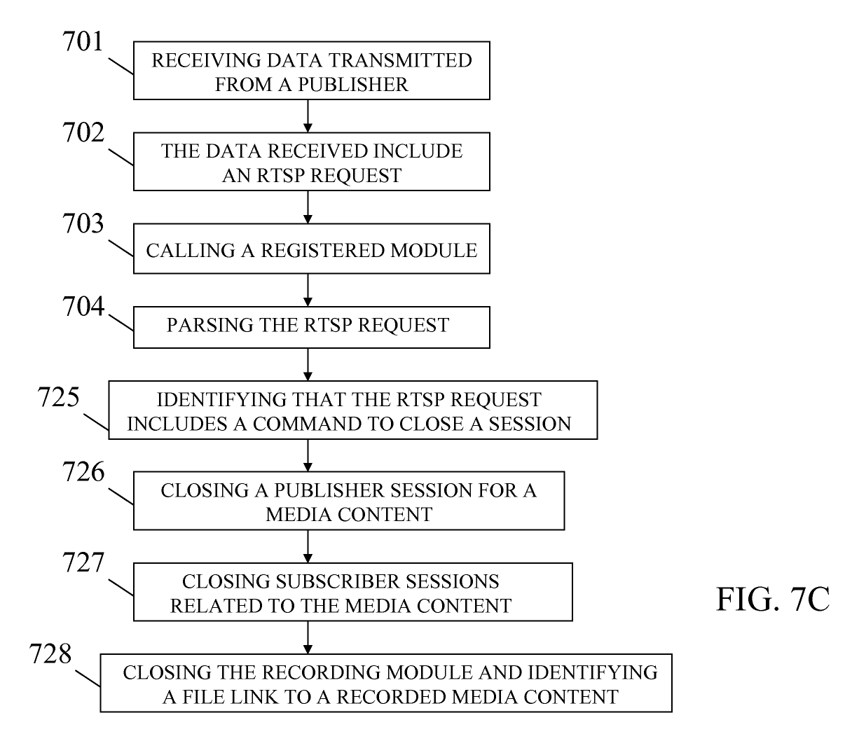

FIG. 6 is a flow diagram illustrating a method of publishing media content consistent with an example of the present invention. Referring to FIG. 6, at step 601, a publisher ID or user ID may be obtained from a user. The publisher ID may be verified at step 602 to identify whether the user is allowed to publish. A user may not be allowed to publish until the user has registered and passes the ID verification. If the ID is authentic, at step 603, a capture module of the user's communication device may be initiated to support real-time media communication. At step 604, a location such as a URL or URI of a streaming server unit for the current publishing may be obtained by a blog server unit. Next, at step 605, a file format of the real-time media content may be provided. The file format may facilitate identifying actions in the streaming server unit, including initiating, writing and closing a media file in, for example, a “3GP” file format, which will be described below with reference to FIGS. 7A to 7C.

Next, a web page for the real-time media content may be created at step 606, and the location of the real-time media content may be included in the web page created at step 606. The user may then send the real-time media content in packets to the streaming server unit at step 607. The user may identify whether to publish continuous real-time media content at step 608, wherein the continuous real-time media content may refer to one that has the same location as a previously published media content. If confirmative, the steps 607 and 608 may be repeated until no continuous real-time media content needs to be published. If not, the location of the media content may be modified and the publishing may be finished at step 609. While publishing the continuous real-time media content, the comment module may be accessed at step 610. At step 611, it may be identified whether there are comments from subscribers on the real-time media content. If confirmative, the user may view the subscriber's comments at step 612. The user may decide whether to respond to the subscriber's comments at step 613. If confirmative, the user may leave his or her own comment at step 614. The steps 611 to 614 may then be repeated until the publishing is finished at step 609.

FIGS. 7A, 7B and 7C are exemplary flow diagrams illustrating a method of real-time media communication consistent with an example of the present invention. Specifically, FIGS. 7A to 7C illustrate the operation of the streaming server unit 18 when a publisher has obtained the location of the streaming server unit 18 from the blog server unit 16 and is ready to publish real-time media content. Referring to FIG. 7A, at step 701, data sent from a publisher may be received by a streaming server unit such as the streaming server unit 18 described and illustrated with reference to FIG. 1B. The data may include a file name such as, for example, Real Time Streaming Protocol (RTSP) or Real-time Transport Protocol (RTP). The RTSP may refer to a protocol for use in streaming media systems, which may allow a client to remotely control a streaming media server, issuing VCR-like commands such as “play” and “pause”, and allowing time-based access to files on a server. The RTP may define a standard packet format for delivering audio and video over the Internet. In general, an RTSP request may include commands for communication, while an RTP packet may include audio data or video data.

At step 702, the data received may include an RTSP request. A registered module, for example, a file module or a session description protocol (SDP) module, may be called at step 703. Specifically, the file module may be called if a file extension of the file name includes a file format such as, for example, 3GP, MP4 or AVI. In one example according to the present invention, the file module may be called when a user requests for accessing a media file recorded in the content recording module 183. Furthermore, the SDP module may be called if, for example, a file extension of the file name includes “SDP”. In one example, the SDP module may be called when a user requests for publishing a real-time media content.

The RTSP request may be parsed at step 704, which may include commands and a payload. At step 705, the commands contained in the RTSP request such as “Announce”, “Setup” and “Play” may be executed. For example, the command “Announce” may specify a file format of a media content such as the 3GP, MPEG4 and AMR formats. The command “Setup” may specify a transmission mechanism such as communication ports or sockets for transmitting the media content. Furthermore, the command “Play” may start the transmission between the user's communication device 11 or 13 and the streaming server unit 18 in accordance with the file format and transmission ports identified by the commands “Announce” and “Setup”, respectively. An RTSP payload in the RTSP request may then be parsed at step 706. A recording module such as the content recording module 183 described and illustrated with reference to FIG. 1B may then be initiated to record a media file in the file format at step 707. The “3GP” may refer to a simplified version of the MPEG-4 Part 14 (MP4) container format, which may be designed to decrease storage and bandwidth requirements in order to accommodate mobile phones. The “3GP” may store video streams as MPEG-4 or H.263 or H.264, and audio streams as adaptive multi-rate narrowband (AMR-NB) or Advanced Audio Coding-Low Complexity (AAC-LC). In one example according to the present invention, the above-mentioned steps 701 to 707 may be performed at the content receiving module 181 of the streaming server unit 18.

Referring to FIG. 7B, at step 712, the data received may include an RTP packet, which may form a payload portion of an RTSP request. Next, at step 713, a session identity for publishing media content may be identified. The session identity may be different from one media content to another so that each media content has a unique session identity. At step 714, it may be identified that the data include audio or video content. The media content may then be written in a media file at step 715. In one example, the above-mentioned steps 701 and 712 to 713 may be performed at the content receiving module 181 and the step 715 may be performed at the content recording module 183.

Referring to FIG. 7C, at step 725, an RTSP request may include a command such as “Teardown” to close the RTSP connection, for example, after the initiation process and the writing process respectively described and illustrated with reference to FIGS. 7A and 7B are performed. At step 726, a publisher session for publishing a media content may be closed or the corresponding publisher session identity may be deleted. Next, at step 727, a subscriber session related to the media content may be closed or the corresponding subscriber identity may be deleted. The content recording module 183 may then be closed and a file link to a recorded media content may be identified at step 728. The real-time media content recorded by the content recording module 183 may be retrieved using the file link by calling the file module as described and illustrated with reference to step 703, FIG. 7A. In one example according to the present invention, the above-mentioned steps 701 to 704 and 725 to 728 may be performed at the content receiving module 181 of the streaming server unit 18.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the preliminary claims below and the additional claims to be submitted later. In addition, the claims directed to the method and/or process of the present invention should not be limited to the performance of their steps in the order written, and one skilled in the art can readily appreciate that the sequences may be varied and still remain within the spirit and scope of the present invention.

1. A system for real-time media communication, the system comprising:
a first server unit configured to interface between at least one user and a blog, the first server unit comprising:
a publishing control module configured to identify an identity of a publisher of the at least one user, allow the publisher to transmit real-time media content if the identity of the publisher is authentic and receive a description of the real-time media content from the publisher;
a link module configured to obtain a location of the real-time media content so that the location of the real-time media content is accessible to the at least one user; and
a second server unit configured to process the real-time media content in a streaming mode, the second server unit comprising:
a receiving module configured to receive the real-time media content;
a recording module configured to record the real-time media content; and
a dispatching module configured to provide the location of the real-time media content to the publishing module.

2. The system of claim 1, wherein the first server unit is configured to provide a location of the second server unit.

3. The system of claim 1, wherein the dispatching module is configured to provide the location of the real-time media content to the link module.

4. The system of claim 1, wherein the receiving module is configured to identify the identity of the publisher.

5. The system of claim 1, wherein the first server unit further comprises:
a registration module configured to assign an identity to one of the at least one user upon registration and collect a description of interested contents from the one user.

6. The system of claim 5, wherein the registration module is configured to provide a list of subscribers related to the description from the publisher.

7. The system of claim 5, wherein the registration module is configured to receive a list of subscribers from the publisher.

8. The system of claim 1, wherein the first server unit further comprises:
a notifying module configured to notify a group of subscribers based on a list of subscribers related to the description from the publisher.

9. The system of claim 1, wherein the first server unit further comprises:
a notifying module configured to notify a group of subscribers based on a list of subscribers from the publisher.

10. The system of claim 5, wherein the registration module is configured to provide a web page related to the description from the publisher.

11. The system of claim 5, wherein the registration module is configured to provide a web page for a subscriber related to a description from the subscriber.

12. The system of claim 1, wherein the first server unit further comprises:
a comment module configured to provide a location for a comment on media content and collect at least one comment from at least one of the publisher or at least one subscriber.

13. A system for real-time media communication, the system comprising:
a registration module configured to assign an identity to at least one user upon registration and collect a description of interested contents from at least one subscriber of the at least one user;
a publishing module configured to identify an identity of a publisher of the at least one user, allow the publisher to transmit real-time media content if the identity of the publisher is authentic and receive a description of the real-time media content from the publisher;
a link module configured to obtain a location of the real-time media content so that the location of the real-time media content is accessible to the at least one user; and
a notifying module configured to notify a group of subscribers of the real-time media content.

14. The system of claim 13, wherein the registration module is configured to provide a list of subscribers related to the description from the publisher.

15. The system of claim 13, wherein the registration module is configured to receive a list of subscribers from the publisher.

16. The system of claim 13 further comprising a notifying module configured to notify a group of subscribers based on a list of subscribers related to the description from the publisher.

17. The system of claim 13 further comprising a notifying module configured to notify a group of subscribers based on a list of subscribers from the publisher.

18. The system of claim 13, wherein the registration module is configured to provide a web page related to the description from the publisher.

19. The system of claim 13, wherein the registration module is configured to provide a web page for a subscriber related to a description from the subscriber.

20. The system of claim 13 further comprising a comment module configured to provide a location for a comment on media content and collect at least one comment from at least one of the publisher or at least one subscriber.

21. A system for real-time media communication, the system comprising:
a receiving module configured to receive data from a publisher and identify whether the data include a command or a payload, the receiving module performing an initiation process for transmission of real-time media content if the data include a command on initiation, identifying a session for real-time media content if the payload includes the real-time media content and closing a session for the real-time media content if the data include a command on closing;
a recording module configured to record the real-time media content; and
a dispatching module configured to provide a location of the real-time media content.

22. The system of claim 21, wherein the receiving module is configured to identify a file format for the real-time media content and the recording module is initiated by the receiving module to record the real-time media content in the file format.

23. The system of claim 21, wherein the location of the real-time media content includes one of a universal resource locator (URL) and a universal resource identifier (URI).

24. The system of claim 21, wherein the receiving module is configured to close a session for the real-time media content related to the publisher.

25. The system of claim 21, wherein the receiving module is configured to close at least one session for the real-time media content related to at least one subscriber.
